(19) United States
(12) Patent Application Publication
(10) Pub. No.: US 2024/0270245 A1
(43) Pub. Date: Aug. 15, 2024

(54) VEHICLE CONTROL DEVICE

(71) Applicant: TOYOTA JIDOSHA KABUSHIKI KAISHA, Toyota-shi (JP)

(72) Inventor: Hiroshi UENO, Toyota-shi (JP)

(73) Assignee: TOYOTA JIDOSHA KABUSHIKI KAISHA, Toyota-shi (JP)

(21) Appl. No.: 18/428,028

(22) Filed: Jan. 31, 2024

(30) Foreign Application Priority Data
Feb. 13, 2023 (JP) 2023-019874

(51) Int. Cl. B60W 30/14; B60W 30/16

(52) U.S. Cl. CPC B60W 30/143; B60W 30/16; B60W 2554/802

(57) ABSTRACT

A vehicle control device includes a processor that is configured to receive a requested acceleration as one of motion requests from application software that realizes a driver assistance function of a vehicle, configured to generate an instruction value for an action request for controlling an actuator of the vehicle, based on the requested acceleration, configured to determine whether a specified condition that is set in advance is satisfied as a condition indicating that an inter-vehicle distance from the vehicle to a preceding vehicle traveling ahead of the vehicle is short, and configured to output a change signal to the application software to change the requested acceleration such that the inter-vehicle distance is longer, under a condition that the specified condition is satisfied.

### CROSS-REFERENCE TO RELATED APPLICATION

This application claims priority to Japanese Patent Application No. 2023-019874 filed on Feb. 13, 2023, incorporated herein by reference in its entirety.

### BACKGROUND

### 1. Technical Field

The disclosure relates to a vehicle control device.

### 2. Description of Related Art

A vehicle disclosed in Japanese Unexamined Patent Application Publication No. 2014-113913 (JP 2014-113913 A) includes a control device, an accelerator operation amount sensor, and a communication device. The control device acquires an accelerator operation amount of an operation performed by a driver of the vehicle, via the accelerator operation amount sensor. Also, the control device acquires information from a preceding vehicle traveling ahead of the vehicle via the communication device. Specifically, the control device acquires a request value for longitudinal acceleration that the preceding vehicle is attempting to realize. The control device then calculates a request value for the longitudinal acceleration that the own vehicle should realize, based on the accelerator operation amount, the request value for the longitudinal acceleration acquired from the preceding vehicle, and so forth. Inter-vehicle distance from the own vehicle to the preceding vehicle is then adjusted by controlling an actuator of the own vehicle, based on a request value for the longitudinal acceleration that is calculated.

### SUMMARY

Assumption will be made that, in the vehicle control device such as that in JP 2014-113913 A, the inter-vehicle distance between the own vehicle and the preceding vehicle is set to be relatively short. When the inter-vehicle distance is short in this way, and the preceding vehicle decelerates, for example, opportunities for the own vehicle to use friction brakes, which can obtain a relatively large deceleration, increase. As a result, there is a concern that the friction brakes of the own vehicle will wear out prematurely.

A first aspect of the present disclosure is a vehicle control device. The vehicle control device includes a processor. The processor is configured to receive a requested acceleration as one of motion requests from application software that realizes a driver assistance function of a vehicle, configured to generate an instruction value for an action request for controlling an actuator of the vehicle, based on the requested acceleration, configured to determine whether a specified condition that is set in advance is satisfied as a condition indicating that an inter-vehicle distance from the vehicle to a preceding vehicle traveling ahead of the vehicle is short, and configured to output a change signal to the application software to change the requested acceleration such that the inter-vehicle distance is longer, under a condition that the specified condition is satisfied.

In the first aspect, the specified condition may include a requirement that actual acceleration of the vehicle is a negative value and an absolute value of the actual acceleration is greater than a stipulated acceleration set in advance.

In the first aspect, the specified condition may include a requirement that the inter-vehicle distance is short.

In the first aspect, the specified condition may include a requirement that the actual acceleration of the preceding vehicle is a negative value.

In the first aspect, the processor may be configured to output the change signal for changing the requested acceleration such that the inter-vehicle distance is longer, under a condition that a total time in a stipulated period set in advance is no less than a reference time set in advance. The specified condition may be satisfied over the total time.

According to the first aspect, premature wear of the friction brake can be suppressed, due to the inter-vehicle distance being longer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a functional block diagram illustrating a basic configuration of a motion manager; and FIG. 3 is a flowchart showing change control.

### DETAILED DESCRIPTION OF EMBODIMENTS

### Schematic Configuration of Vehicle

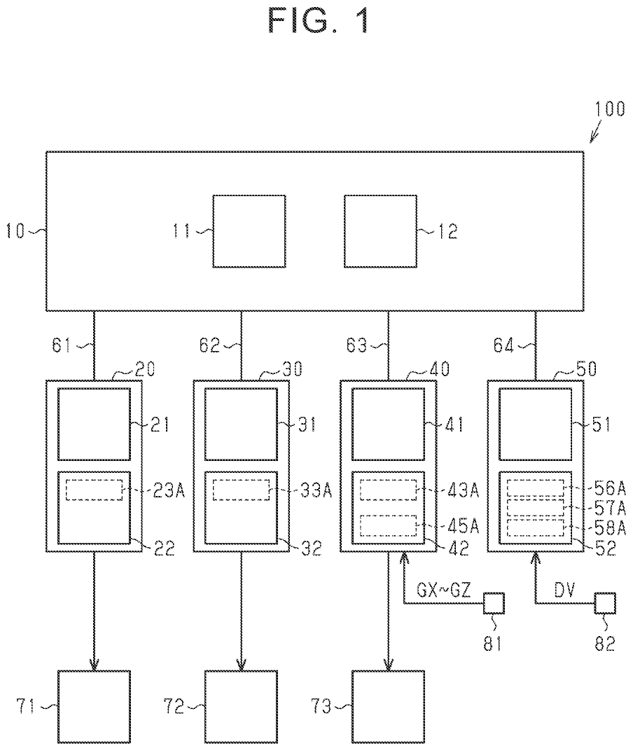

An embodiment of the disclosure will be described below with reference to FIGS. 1 to 3. First, a schematic configuration of a vehicle 100 will be described.

The vehicle 100 includes a powertrain device 71, a steering device 72, and a brake device 73, as illustrated in FIG. 1. The powertrain device 71 includes an engine, a motor generator, a transmission, and so forth. The engine can apply driving force to driving wheels of the vehicle 100 via the transmission. Further, the engine can consume traveling energy of the vehicle 100 by applying the traveling energy from the driving wheels of the vehicle 100 to a crankshaft of the engine, through pumping loss of the engine. That is to say, the engine can apply braking force to the driving wheels of the vehicle 100 by so-called engine braking. Also, the motor generator can apply driving force to the driving wheels of the vehicle 100 via the transmission. Further, the motor generator can consume the traveling energy of the vehicle 100 by converting the traveling energy from the driving wheels of the vehicle 100 into electric energy. That is to say, the motor generator can apply braking force to the driving wheels of the vehicle 100 by so-called regenerative braking.

An example of the steering device 72 is a rack-and-pinion electric steering device. The steering device 72 can change the direction of a steering wheel of the vehicle 100 by controlling a rack and a pinion that are omitted from illustration.

The brake device 73 is a so-called mechanical brake device that mechanically brakes wheels of the vehicle 100. In the present embodiment, the brake device 73 includes disc brakes. Note that a disc brake is an example of a friction brake.

As illustrated in FIG. 1, the vehicle 100 includes a central ECU 10, a powertrain ECU 20, a steering ECU 30, a brake ECU 40, and an advanced driver assistance ECU 50. The vehicle 100 also includes a first external bus 61, a second external bus 62, a third external bus 63, and a fourth external bus 64. Note that the term “ECU” is an abbreviation for “electronic control unit”.

The central ECU 10 centrally controls the vehicle 100 as a whole. The central ECU 10 includes an execution device 11 and a storage device 12. The storage device 12 stores various types of programs and various types of data in advance. Note that the storage device 12 includes read only memory (ROM), random access memory (RAM), and storage. The execution device 11 realizes various types of processing by executing the programs stored in the storage device 12. Note that an example of the execution device 11 is a central processing unit (CPU).

The powertrain ECU 20 can communicate with the central ECU 10 via the first external bus 61. The power train ECU 20 controls the powertrain device 71 by outputting control signals to the powertrain device 71. The powertrain ECU 20 includes an execution device 21 and a storage device 22. The storage device 22 stores various types of programs and various types of data in advance. The storage device 22 also stores a powertrain app 23A as one of the various types of programs in advance. The powertrain app 23A is application software for controlling the powertrain device 71. The storage device 22 includes ROM, RAM, and storage. The execution device 21 realizes a function as a powertrain control unit 23, which will be described later, by executing the powertrain app 23A stored in the storage device 22. Note that an example of the execution device 21 is a CPU.

The steering ECU 30 can communicate with the central ECU 10 via the second external bus 62. The steering ECU 30 controls the steering device 72 by outputting control signals to the steering device 72. The steering ECU 30 includes an execution device 31 and a storage device 32. The storage device 32 stores various types of programs and various types of data in advance. The storage device 32 also stores a steering app 33A as one of the various types of programs in advance. The steering app 33A is application software for controlling the steering device 72. Note that the storage device 32 includes ROM, RAM, and storage. The execution device 31 realizes a function as a steering control unit 33, which will be described later, by executing the steering app 33A stored in the storage device 32. Note that an example of the execution device 31 is a CPU.

The brake ECU 40 can communicate with the central ECU 10 via the third external bus 63. The brake ECU 40 controls the brake device 73 by outputting control signals to the brake device 73. The brake ECU 40 includes an execution device 41 and a storage device 42. The storage device 42 stores various types of programs and various types of data in advance. The storage device 42 also stores a brake app 43A as one of the various types of programs in advance. The brake app 43A is application software for controlling the brake device 73. The storage device 42 further stores a motion manager app 45A as one of the various types of programs in advance. The motion manager app 45A is application software for arbitration of a plurality of motion requests. Note that the storage device 42 includes ROM, RAM, and storage. The execution device 41 realizes a function as a brake control unit 43, which will be described later, by executing the brake app 43A stored in the storage device 42. Also, the execution device 41 realizes a function as a motion manager 45, which will be described later, by executing the motion manager app 45A stored in the storage device 42. Note that an example of the execution device 41 is a CPU. In the present embodiment, the brake ECU 40 is a control device of the vehicle 100.

The advanced driver assistance ECU 50 can communicate with the central ECU 10 via the fourth external bus 64. The advanced driver assistance ECU 50 executes various types of driver assistance. The advanced driver assistance ECU 50 includes an execution device 51 and a storage device 52. The storage device 52 stores various types of programs and various types of data in advance. The various types of programs include a first assistance app 56A, a second assistance app 57A, and a third assistance app 58A. An example of the first assistance app 56A is application software for collision damage mitigation braking, that is, so-called autonomous emergency braking (AEB), that automatically applies braking in order to mitigate damage of a collision on the vehicle 100. An example of the second assistance app 57A is application software for so-called lane keeping assist (LKA) that maintains the lane in which the vehicle 100 is traveling. An example of the third assistance app 58A is application software for so-called adaptive cruise control (ACC) that allows the vehicle 100 to follow a preceding vehicle traveling ahead of the vehicle 100 while keeping the inter-vehicle distance constant. In the present embodiment, the first assistance app 56A, the second assistance app 57A, and the third assistance app 58A are each application software for realizing driver assistance functions of the vehicle 100. The storage device 52 includes ROM, RAM, and storage. The execution device 51 realizes a function as a first assistance unit 56, which will be described later, by executing the first assistance app 56A stored in the storage device 52. The execution device 51 also realizes a function as a second assistance unit 57, which will be described later, by executing the second assistance app 57A stored in the storage device 52. The execution device 51 realizes a function as a third assistance unit 58, which will be described later, by executing the third assistance app 58A stored in the storage device 52. Note that an example of the execution device 51 is a CPU.

As illustrated in FIG. 1, the vehicle 100 includes an acceleration sensor 81 and an inter-vehicle distance sensor 82. The acceleration sensor 81 is a so-called triaxial sensor. That is to say, the acceleration sensor 81 can detect longitudinal acceleration GX, lateral acceleration GY, and vertical acceleration GZ. The longitudinal acceleration GX is acceleration along a longitudinal axis of the vehicle 100. The lateral acceleration GY is acceleration along a lateral axis of the vehicle 100. The vertical acceleration GZ is acceleration along a vertical axis of the vehicle 100. The inter-vehicle distance sensor 82 detects an inter-vehicle distance DV that is a distance from the vehicle 100 to a preceding vehicle traveling ahead of the vehicle 100. An example of the inter-vehicle distance sensor 82 is a LIDAR device. Note that the term “LIDAR” is an abbreviation for “Laser Imaging Detection and Ranging”.

The brake ECU 40 acquires signals indicating the longitudinal acceleration GX, the lateral acceleration GY, and the vertical acceleration GZ, from the acceleration sensor 81. The advanced driver assistance ECU 50 acquires signals indicating the inter-vehicle distance DV, from the inter-vehicle distance sensor 82. Also, the brake ECU 40 can acquire various types of values, including the inter-vehicle distance DV, via the central ECU 10. Further, the brake ECU 40 calculates a preceding vehicle acceleration GXP, which is acceleration along the longitudinal axis of a preceding vehicle, at each control cycle that is set in advance, under the condition that there is a preceding vehicle traveling ahead of the vehicle 100. For example, the brake ECU 40 calculates the preceding vehicle acceleration GXP based on an amount of change per unit time of the longitudinal acceleration GX and an amount of change per unit time of the inter-vehicle distance DV.

### Basic Configuration Relating to Motion Manager

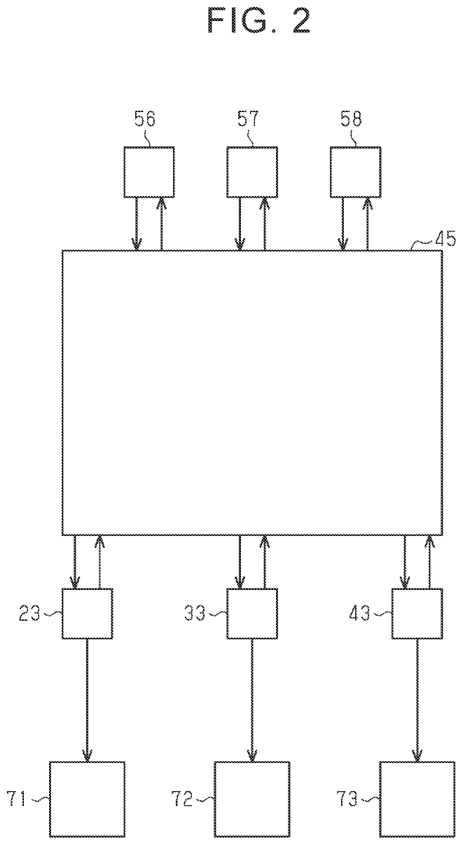

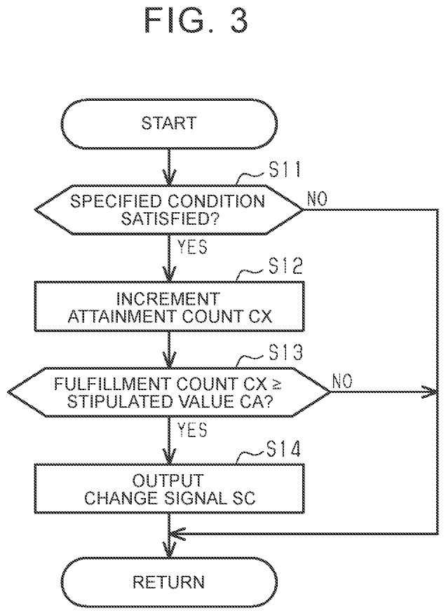

Next, a basic configuration relating to the motion manager 45 will be described with reference to FIG. 2. As illustrated in FIG. 2, the motion manager 45 can mutually communicate with the first assistance unit 56, the second assistance unit 57, and the third assistance unit 58. The motion manager 45 can also mutually communicate with the powertrain control unit 23, the steering control unit 33, and the brake control unit 43.

The first assistance unit 56, the second assistance unit 57, and the third assistance unit 58 output motion requests to the motion manager 45 when executing various types of control. At this time, the first assistance unit 56, the second assistance unit 57, and the third assistance unit 58 continue to output the motion requests from when the various types of control become necessary until such control is not needed any more, for example. Now, motion requests include a requested longitudinal acceleration GXR for controlling the acceleration along the longitudinal axis of the vehicle 100, and so forth. In the present embodiment, the requested longitudinal acceleration GXR is a type of requested acceleration.

As illustrated in FIG. 2, the motion manager 45 receives the motion requests from the first assistance unit 56, the second assistance unit 57, and the third assistance unit 58. In the present embodiment, receiving motion requests from the first assistance unit 56, the second assistance unit 57, and the third assistance unit 58, is equivalent to receiving motion requests from the application software that realizes the driver assistance functions of the vehicle 100. Also, the motion manager 45 performs arbitration of the received motion requests. For example, when the motion manager 45 receives requested longitudinal acceleration GXR from a plurality of assistance unit, the motion manager 45 selects the requested longitudinal acceleration GXR that was received at the earliest timing as the result of arbitration. The motion manager 45 then generates instruction values for action requests for controlling various types of actuators, based on the result of arbitration. Now, the various types of actuators include the powertrain device 71, the steering device 72, the brake device 73, and so forth. For example, when controlling the powertrain device 71, the motion manager 45 outputs an instruction value for an action request to the powertrain control unit 23. The powertrain control unit 23 then outputs a control signal to the powertrain device 71 based on the instruction value of the action request. Thus, the instruction values output by the motion manager 45 are received by the control units corresponding to the actuators to be controlled, and the actuators are controlled by the respective control units.

### Change Control

Next, change control executed by the motion manager 45 will be described with reference to FIG. 3. In the present embodiment, the motion manager 45 repeatedly executes the change control under the condition that the motion manager 45 has received the requested longitudinal acceleration GXR and that there is a preceding vehicle traveling ahead of the vehicle 100.

When the change control is started, as shown in FIG. 3, the motion manager 45 executes the processing of step S11. In step S11, the motion manager 45 determines whether a specified condition that is set in advance, under the condition of indicating that the inter-vehicle distance DV is short, is satisfied. Specifically, the motion manager 45 determines that the specified condition is satisfied when all of the following Requirements (1) to (3) are satisfied.

Requirement (1): The longitudinal acceleration GX is a negative value, and the absolute value of the longitudinal acceleration GX is greater than a stipulated acceleration A that is set in advance.

Now, the longitudinal acceleration GX takes a positive value when the vehicle 100 is accelerating. On the other hand, the longitudinal acceleration GX takes a negative value when the vehicle 100 is decelerating. In the present embodiment, the longitudinal acceleration GX is an actual acceleration of the vehicle 100. Also, the stipulated acceleration

A is defined as follows, for example. First, out of the devices capable of applying braking force to the driving wheels of the vehicle 100, a device, other than the friction brakes, which can yield the greatest deceleration, is identified through experimentation or the like. Also, the greatest value of deceleration that can be realized is found for the device that is identified. The absolute value of the deceleration that is found is then set as the stipulated acceleration A. Accordingly, when the vehicle 100 is decelerating at a rate that necessitates applying the friction brakes, for example, the motion manager 45 determines that Requirement (1) is satisfied. Note that, as described above, devices capable of applying braking force to the driving wheels of the vehicle 100 include, for example, the engine of the powertrain device 71, the motor generator of the powertrain device 71, and the disc brakes of the brake device 73.

Requirement (2): The inter-vehicle distance DV has become shorter.

For example, when the inter-vehicle distance DV at the processing point in time of step S11 is shorter than the inter-vehicle distance DV at a point in time earlier than the processing point in time of step S11 by a unit time, the motion manager 45 determines that Requirement (2) is satisfied. Note that an example of the unit time is a control cycle of the change control.

Requirement (3): The preceding vehicle acceleration GXP is a negative value.

Now, the preceding vehicle acceleration GXP takes a positive value when the preceding vehicle is accelerating. On the other hand, the preceding vehicle acceleration GXP takes a negative value when the preceding vehicle is decelerating. Therefore, when the preceding vehicle is decelerating, the motion manager 45 determines that Requirement (3) is satisfied. In the present embodiment, the preceding vehicle acceleration GXP is the actual acceleration of the preceding vehicle.

When the motion manager 45 determines in step S11 that the specified condition is not satisfied (NO in S11), the motion manager 45 ends the current change control. The motion manager 45 then advances the processing to step S11 again. On the other hand, when the motion manager 45 determines in step S11 that the specified condition is satisfied (YES in S11), the motion manager 45 advances the processing to step S12.

In step S12, the motion manager 45 increments a fulfilment count CX by “1”. Now, the fulfilment count CX indicates the count of times the specified condition is satisfied during one trip. The motion manager 45 resets the fulfilment count CX each time the system of the vehicle 100 is activated, specifically, each time the brake ECU 40 is activated. Also, the initial value of the fulfilment count CX is zero. Note that “one trip” is a period from when the system of the vehicle 100 is activated until when the system is shut down. In this embodiment, “1 trip” is an example of a stipulated period that is set in advance. After step S12, the motion manager 45 advances the processing to step S13.

In step S13, the motion manager 45 determines whether the fulfilment count CX is no smaller than a stipulated value CA that is set in advance. Now, a fulfilment count CX of no smaller than the stipulated value CA means that the specified condition was satisfied during a period obtained by multiplying the control cycle of the change control by the stipulated value CA. That is to say, the processing in step S13 is processing of determining whether total time during which the specified condition was satisfied in a stipulated period set in advance is no less than a reference time that is set in advance. In step S13, when the motion manager 45 determines that the fulfilment count CX is less than the stipulated value CA (NO in S13), the motion manager 45 ends the current change control. The motion manager 45 then advances the processing to step S11 again. On the other hand, when the motion manager 45 determines in step S13 that the fulfilment count CX is no smaller than the stipulated value CA (YES in S13), the motion manager 45 advances the processing to step S14. In other words, the motion manager 45 advances the processing to step S14 under the condition that the total time during which the specified condition was satisfied in the stipulated period that is set in advance is no less than the reference time that is set in advance.

In step S14, the motion manager 45 outputs a change signal SC to the application software that outputs the requested longitudinal acceleration GXR, to change the requested longitudinal acceleration GXR such that the inter-vehicle distance DV is longer. Assumption will be made, for example, that the requested longitudinal acceleration GXR received from the first assistance unit 56 is selected as the arbitration result. In this case, the motion manager 45 outputs a change signal SC to the first assistance unit 56 to change the requested longitudinal acceleration GXR, such that the inter-vehicle distance DV longer. After step S14, the motion manager 45 ends the current change control. The motion manager 45 then advances the processing to step S11 again.

### Functions of Present Embodiment

Assumption will be made that the motion manager 45 is executing change control, due to the motion manager 45 having received the requested longitudinal acceleration GXR, and also there being a preceding vehicle that is traveling ahead of the vehicle 100. Assumption will also be made that a specified condition that is set in advance, under the condition of indicating that the inter-vehicle distance DV is short, is satisfied. The motion manager 45 then executes the processing of step S14 under the condition that affirmative determination is made in step S11, i.e., the specified condition is satisfied. Here, assumption will be made that, for example, the motion manager 45 has selected the requested longitudinal acceleration GXR received from the first assistance unit 56 as the arbitration result. In this case, the motion manager 45 outputs a change signal SC to the first assistance unit 56 to change the requested longitudinal acceleration GXR, such that the inter-vehicle distance DV longer. Upon receiving the change signal SC, the first assistance unit 56 changes the requested longitudinal acceleration GXR to a smaller value than before. By the first assistance unit 56 changing the requested longitudinal acceleration GXR in this way, the requested longitudinal acceleration GXR received by the motion manager 45 is also smaller. As a result, the actual longitudinal acceleration GX of the vehicle 100 decreases relative to the preceding vehicle acceleration GXP of the preceding vehicle, and accordingly the inter-vehicle distance DV becomes longer.

### Effects of Present Embodiment

(1) According to the present embodiment, when the specified condition is satisfied, i.e., when opportunities of using the friction brake increase, the inter-vehicle distance DV becomes longer by changing the requested longitudinal acceleration GXR.

When the inter-vehicle distance DV is made to be longer in this way, there is a higher likelihood that braking force that can be applied by the engine and the motor generator of the powertrain device 71, for example, without using the friction brake, will suffice. The opportunities of using the friction brakes are reduced in this way, and accordingly the friction brakes can be suppressed from wearing out prematurely.

(2) In general, in a situation in which the longitudinal acceleration GX is a negative value and the absolute value of the longitudinal acceleration GX is greater than the stipulated acceleration A that is set in advance, the friction brake is more likely to be used. In the present embodiment, the specified condition in step S11 includes requirements that the longitudinal acceleration GX is a negative value and that the absolute value of the longitudinal acceleration GX is greater than the stipulated acceleration A that is set in advance. Accordingly, in a situation in which the friction brake is particularly likely to be used, the requested longitudinal acceleration GXR can be changed such that the inter-vehicle distance DV is longer.

(3) In general, in a situation in which the inter-vehicle distance DV is short, the likelihood that the friction brake will be used is high. In the present embodiment, the specified condition in step S11 includes a requirement that the inter-vehicle distance DV is short. Accordingly, in a situation in which the friction brake is particularly likely to be used, the requested longitudinal acceleration GXR can be changed such that the inter-vehicle distance DV is longer.

(4) In general, in a situation in which the preceding vehicle acceleration GXP is a negative value, i.e., in a situation in which the preceding vehicle is decelerating, the likelihood that the friction brake of the vehicle 100 will be used is high. In the present embodiment, the specified condition in step S11 includes a requirement that the preceding vehicle acceleration GXP is a negative value. Accordingly, in a situation in which the friction brake is particularly likely to be used, the requested longitudinal acceleration GXR can be changed such that the inter-vehicle distance DV is longer.

(5) In step S11, the motion manager 45 determines that the specified condition is satisfied when all of the Requirements (1) to (3) described above are satisfied. Accordingly, the specified condition can be determined to be satisfied in a situation in which the likelihood of using the friction brake is extremely high, as compared to a configuration in which determination is made that the specified condition is satisfied when one or more of the Requirements (1) to (3) are satisfied, for example.

(6) In general, the longer the total time over which the specified condition is satisfied is, the more the wear of the friction brake progresses. In the present embodiment, the motion manager 45 outputs a change signal SC for changing the requested longitudinal acceleration GXR such that the inter-vehicle distance DV is longer, under the condition that the fulfilment count CX is no smaller than the stipulated value CA that is set in advance. In other words, the motion manager 45 outputs a change signal SC for changing the requested longitudinal acceleration GXR such that the inter-vehicle distance DV is longer, under the condition that the total time, during which the specified condition is satisfied in a stipulated period that is set in advance, is no less than a reference time that is set in advance. Accordingly, the requested longitudinal acceleration GXR can be changed such that the inter-vehicle distance DV is longer in a situation in which wear of the friction brake is likely to progress, while suppressing unnecessary change in the requested longitudinal acceleration GXR to make the inter-vehicle distance DV longer.

### Modifications

The present embodiment can be carried out modified as follows. The present embodiment and the following modifications can be combined with each other and carried out, insofar as no technical contradiction occurs.

In the above embodiment, the change control may be changed. For example, the method of determining the specified condition in step S11 may be changed. As a specific example, the motion manager 45 may determine that the specified condition is satisfied when one or more of Requirements (1) to (3) are satisfied.

For example, the requirements for the specified condition in step S11 may be changed. As a specific example, just part of Requirements (1) to (3) may be employed. Further, as a specific example, in addition to or instead of the Requirements (1) to (3), the motion manager 45 may determine that the specified condition is satisfied when satisfying a requirement that the inter-vehicle distance DV is no more than a stipulated distance that is set in advance. At this time, the stipulated distance is preferably increased as the vehicle speed of vehicle 100 increases. Accordingly, requirements other than Requirements (1) to (3) may be employed as requirements for the specified condition in step S11.

For example, the stipulated period in step S12 may be changed. As a specific example, the stipulated period in step S12 may be a period from the point in time of the processing in step S12 to a certain period before.

For example, the processing of step S13 may be omitted. As a specific example, the motion manager 45 may advance the processing to step S14 when an affirmative determination is made in the processing of step S11. In this case, the processing of step S12 can also be omitted.

In the above embodiment, the configuration of the vehicle 100 may be changed. For example, the ECU that realizes the function of the motion manager 45 may be other than the brake ECU 40. In a specific example, instead of the brake ECU 40, the execution device 11 of the central ECU 10 may realize the function of the motion manager 45 by executing the motion manager app 45A stored in the storage device 12. That is to say, the central ECU 10, the powertrain ECU 20, the steering ECU 30, the brake ECU 40, and the advanced driver assistance ECU 50 may be employed as the control device of the vehicle 100.

For example, the ECU that outputs the requested longitudinal acceleration GXR to the brake ECU 40 is not limited to the advanced driver assistance ECU 50. As a specific example, the ECU that outputs the requested longitudinal acceleration GXR to the brake ECU 40 may be a so-called ADK that is assembled into the vehicle 100 after the point in time of manufacturing of the vehicle 100. Note that when an ADK is employed, the inter-vehicle distance DV may be shortened due to the ADK, and accordingly the present technology is preferably employed. Note that ADK is an abbreviation for Autonomous Driving Kit.

What is claimed is:

1. A vehicle control device comprising a processor that is configured to
receive a requested acceleration as one of motion requests from application software that realizes a driver assistance function of a vehicle,
generate an instruction value for an action request for controlling an actuator of the vehicle, based on the requested acceleration,
determine whether a specified condition that is set in advance is satisfied as a condition indicating that an inter-vehicle distance from the vehicle to a preceding vehicle traveling ahead of the vehicle is short, and
output a change signal to the application software to change the requested acceleration such that the inter-vehicle distance is longer, under a condition that the specified condition is satisfied.

2. The vehicle control device according to claim 1, wherein the specified condition includes a requirement that actual acceleration of the vehicle is a negative value and an absolute value of the actual acceleration is greater than a stipulated acceleration set in advance.

3. The vehicle control device according to claim 1, wherein the specified condition includes a requirement that the inter-vehicle distance is short.

4. The vehicle control device according to claim 1, wherein the specified condition includes a requirement that an actual acceleration of the preceding vehicle is a negative value.

5. The vehicle control device according to claim 1, wherein:
the processor is configured to output the change signal for changing the requested acceleration such that the inter-vehicle distance is longer, under a condition that a total time in a stipulated period set in advance is no less than a reference time set in advance; and
the specified condition is satisfied over the total time.
